(19) United States
(12) Patent Application Publication
(10) Pub. No.: US 2008/0000563 A1
(43) Pub. Date: Jan. 3, 2008

(54) STRUCTURE OF A TIRE FOR VEHICLES

(76) Inventor: Jui-Pin LIA, Nantou Hsien (TW)

Correspondence Address: LEONG C. LEI, PMB #1008, 1867 YGNACIO VALLEY RD., WALNUT CREEK, CA, 94598, US

(21) Appl. No.: 11/766,798

(22) Filed: Jun. 22, 2007

(30) Foreign Application Priority Data
Jun. 23, 2006 (TW) 095211131

(51) Int. Cl. B60C 11/24

(52) U.S. Cl. 152/154.2

(57) ABSTRACT

An improvement in the structure of a tire for vehicle is disclosed. The tire has tire surface formed between the top edge of the external shoulder and the internal shoulder characterized in that the tire surface and the intersection area of the external shoulder and the internal shoulder are respectively formed into a tire surface external edge and a tire surface internal edge, wherein the inner edge is lower than the external edge such that the tire surface forms a sloping face with an inclined angle in response to suspension system of the vehicle, whereby the tire formed has a large contact surface with the ground without wears at one side of the tire.

### BACKGROUND OF THE INVENTION

(a) Technical Field of the Invention

The present invention relates to tire, and in particular, a tire for vehicle which allows or maintain full surface contact of tire with the ground surface.

(b) Description of the Prior Art

Tires of a vehicle are important components of the vehicle in driving. The quality of the tire will absolutely affect the safety and comfort of the vehicle and the longevity of the tire. FIGS. 1, 2 and 3 are conventional tire 10 made from rubber material and the two lateral sides of the tire are the shoulders 11 which are provided for engagement with a wheel hud. In between the two shoulders 15, a horizontal tire face 15 is formed. The tire face 15 maintains in contact with the ground. In order to improve the grip between the tire and the ground, the tire face 15 is provided with a plurality of threads. However, when the set of tire 10 is mounted at the ends of the suspension system 30 of a vehicle, when a vehicle is driving along a corner, the front and rear wheels of the vehicle have to maintain in a curve, the suspension system will allow the tires 10 at the two ends to incline inwardly in order to maintain a balance.

However, this will cause the tire face 15 and the ground surface to form an angle, as shown in FIG. 3. This will reduce the surface in contact with the ground and will cause wears at one side of the tire face 15. In more serious situation, the grip between the tire face 15 and the ground surface decreases, and the driving is unsafe, and affects the safety and comfort of driving. When the weight of a vehicle increases to cause more contact between the tire surface 15 and the ground, it still causes more contact at one side of the tire. In other words, the inner edge of the tire face 15 of the tire 10 will cause a greater deformation. As a result, the tire 10 may be exploded.

Accordingly, it is an object of the present invention to mitigate the above drawbacks to provide an improvement in the structure of a tire for vehicles.

### SUMMARY OF THE INVENTION

The primary purpose of the present invention is to provide an improvement in the structure of a tire for vehicles having an external shoulder and an internal shoulder, and a tire surface formed between the top edge of the external shoulder and the internal shoulder characterized in that the tire surface and the intersection area of the external shoulder and the internal shoulder are respectively formed into a tire surface external edge and a tire surface internal edge, wherein the inner edge is lower than the external edge such that the tire surface forms a sloping face with an inclined angle in response to suspension system of the vehicle, whereby the tire formed has a large contact surface with the ground without wears at one side of the tire.

Yet still another object of the present invention is to provide an improvement in the structure of a tire for vehicles, wherein the height of the external shoulder is higher than that of the internal shoulder and the thickness of the tire surface is equal such that the height of the external edge of the tire surface is higher than that of the inner edge of the tire surface and the tire surface has an inclined sloping.

Yet a further object of the present invention is to provide an improvement in the structure of a tire for vehicles, wherein the external shoulder of the tire is equal in height with the inner shoulder and the thickness of the external edge of the tire surface is thicker than that of the inner edge of the tire surface, and the external edge of the tire surface is higher than the inner edge of the tire face to form a sloping inclined inwardly.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional tire.

FIG. 2 is a sectional view of a conventional tire.

FIG. 3 is a schematic view of conventional tire in application.

FIG. 4 is a sectional view of a tire of the present invention.

FIG. 5 is a sectional view of another preferred embodiment of the present invention.

FIG. 6 is a schematic view of the tire in application in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

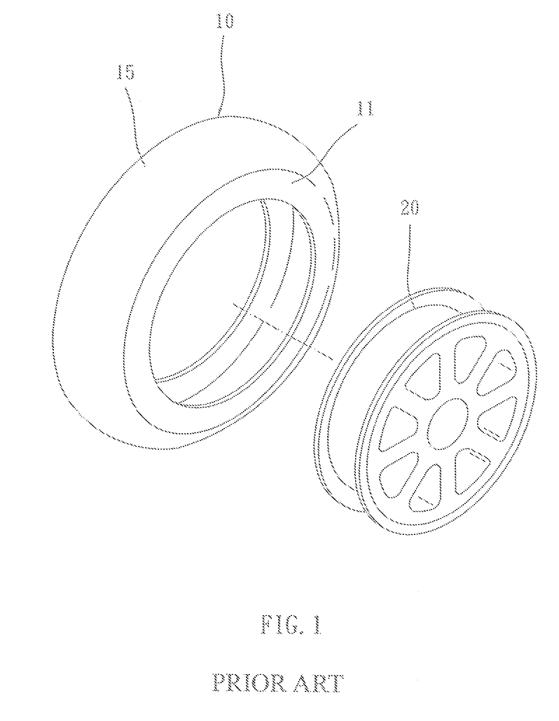

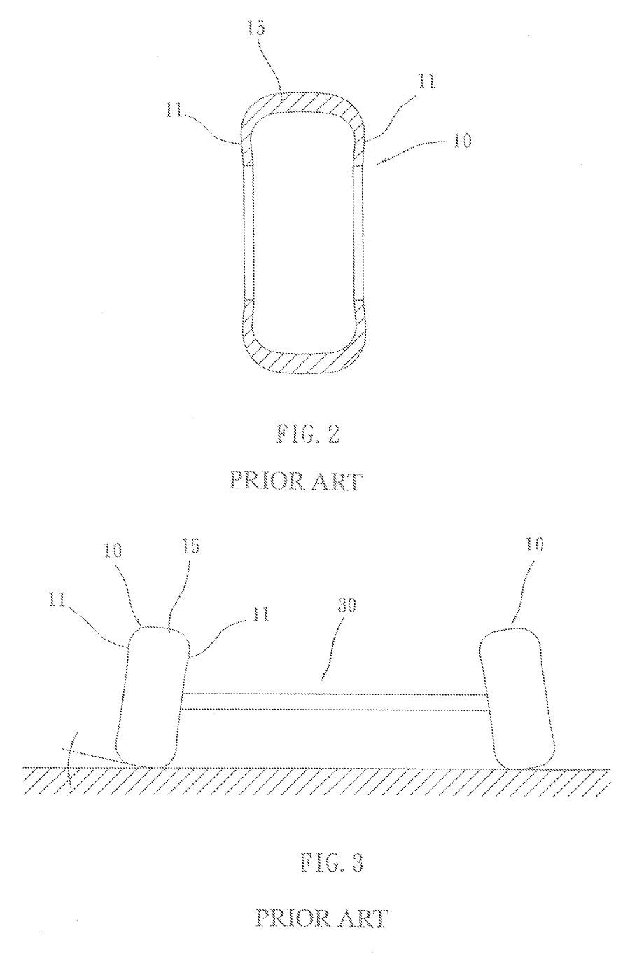

Referring to FIG. 1, there is shown an improvement structure in tire 50 for vehicle having an external shoulder 51 and an inner shoulder 52. In between the top edge of the external shoulder 51 and the inner shoulder 52, a tire face 55 is provided and is used to make contact with the ground in driving.

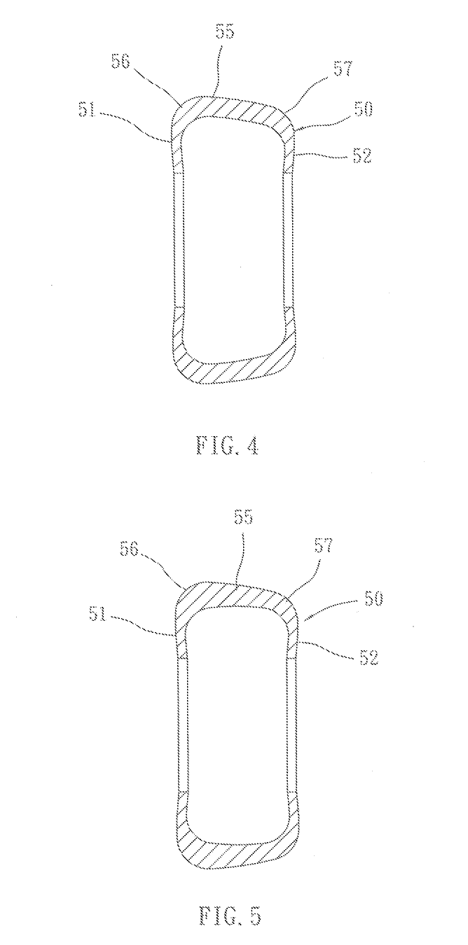

In accordance with a preferred embodiment of the present invention, as shown in FIGS. 4 and 5, the tire face 55 and the intersection area between the external shoulder 51 and the inner shoulder 52 are respectively formed into an external edge 56 and an inner edge 57. The inner edge 57 is lower than the external edge 56 such that the tire face 55 forms into a sloping face with an inwardly inclined angle corresponding to the suspension system of a vehicle.

In accordance with the present invention, there are two ways of forming a sloping face. As shown in FIG. 1, the external shoulder 51 of the external edge 56 is higher than the inner shoulder 52, and the thickness of the tire face 56 is identical. Thus, the external edge 56 of the tire face 56 is higher than the inner edge 57 such that the tire face 55 is formed with a sloping face inclined inwardly. FIG. 5 shows a second method, the external shoulder 51 and the inner shoulder 52 are of the same height, and the thickness of the external edge 56 is thicker than the inner edge 57. Thus, the external edge 56 is higher than the inner edge 57 of the tire face 57 and the tire face 55 is thus formed with a sloping face inclined inwardly.

Thus, the tire face of the present invention allows a large contact surface area with the ground, and the wear at one side of the tire is avoided.

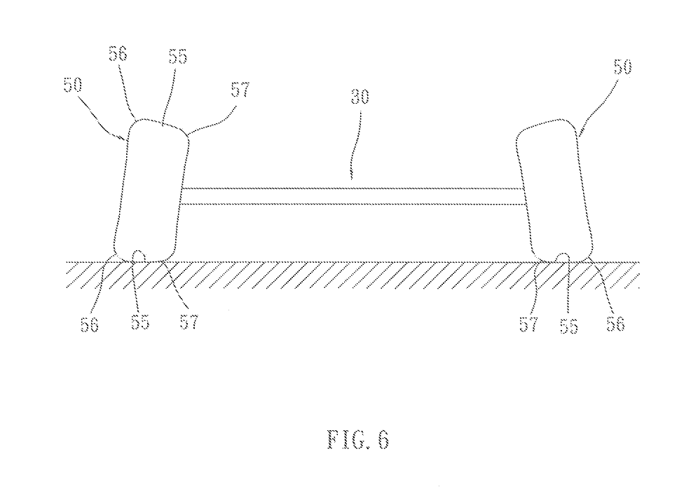

Referring to FIG. 6, the tire 50 is mounted at the suspension system of the vehicle and the tire face 55 with inclined slope increases the area of in contact. Accordingly, one side wear problem is avoided and the deformation at one side of the tire is avoided. Further, the weight exerted at one side of the tire, causing deformation of tire is also avoided. Thus the tire of the present invention has a longevity and the stability of tire is improved. Due to the larger surface area of in contact, the grip of the time on the group is greatly improved and vehicles mounted into this tires provide a safety and a comfortable driving.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improvement in the structure of a tire for vehicles having an external shoulder and an internal shoulder, and a tire surface formed between the top edge of the external shoulder and the internal shoulder characterized in that the tire surface and the intersection area of the external shoulder and the internal shoulder are respectively formed into a tire surface external edge and a tire surface internal edge, wherein the inner edge is lower than the external edge such that the tire surface forms a sloping face with an inclined angle in response to suspension system of the vehicle, whereby the tire formed has a large contact surface with the ground without wears at one side of the tire.

2. The tire of claim 1, wherein the height of the external shoulder is higher than that of the internal shoulder and the thickness of the tire surface is equal such that the height of the external edge of the tire surface is higher than that of the inner edge of the tire surface and the tire surface has an inclined sloping.

3. The tire of claim 1, wherein the external shoulder of the tire is equal in height with the inner shoulder and the thickness of the external edge of the tire surface is thicker than that of the inner edge of the tire surface, and the external edge of the tire surface is higher than the inner edge of the tire face to form a sloping inclined inwardly.
